(19) United States
(12) Patent Application Publication
(10) Pub. No.: US 2004/0233901 A1
(43) Pub. Date: Nov. 25, 2004

(54) Method and apparatus for establishing a wireless voice-over-IP telecommunication

(76) Inventor: Kevin Sung, Taipei Hsien (TW)

Correspondence Address: VARNDELL & VARNDELL, PLLC, 106-A S. COLUMBUS ST., ALEXANDRIA, VA, 22314, US

(21) Appl. No.: 10/442,939

(22) Filed: May 22, 2003

(51) Int. Cl. H04L 12/66

(52) U.S. Cl. 370/356

(57) ABSTRACT

A method and an apparatus for establishing a wireless VoIP telecommunication provides a standard interface, such as an USB interface, for connection with a computer. The apparatus further has a data distributing circuit, a storage unit and a bluetooth module. When the apparatus is connected to the computer, the apparatus acts as a flash drive to store information and will undergo a verifying process. If the verified result is valid, the bluetooth module is activated. Therefore, a user's voice signals is wirelessly received by the bluetooth module and then transmitted to a remote person through the internet networks whereby a VoIP telecommunication is established.

### BACKGROUND OF THE INVENTION

1. Field of Invention

The present invention relates to a method and apparatus for the voice-over-IP (VoIP) telecommunication, and more particularly to a method and apparatus that integrates with bluetooth technology to accomplish wireless and mobile VoIP telecommunication.

2. Related Art

Voice-over-IP (VoIP) is an emerging technology where packet-switched networks employ the Internet Protocol (IP) to offer telephony services. Examples of such networks are the Internet and private IP-based corporate local area networks (LANs) and wide area networks (WANs). The main advantage of using this technology over Plain Old Telephone Service (POTS) is the cost savings obtained from its reduced bandwidth requirements. VoIP shares the network bandwidth with other information types like data and video. Therefore, for example, a company can use a portion of the bandwidth of its existing IP network to offer VoIP to its employees. Consequently, the company can do away with their traditional phone services and their associated costs.

However, when the user utilizes VoIP technology to achieve the telecommunication with other remote persons, the computer is a necessary means to perform such a task. Thus, for either the phone caller or recipient, both must just sit in front of the computer. Such a location limitation is a great inconvenience for effective communication as modern telephone users are already accustomed to mobile telephony.

Thus, a method and apparatus for achieving the mobile VoIP telecommunication in accordance with the present invention obviates or mitigates the aforementioned drawbacks.

### SUMMARY OF THE INVENTION

The main objective of the present invention is to provide a method and apparatus for establishing a wireless VoIP telecommunication, wherein the method and the apparatus employs bluetooth technology to allow a user to easily make a wireless VoIP telecommunication even when the user is far away from the computer.

To achieve the objective of the present invention, the method includes the steps of:

receiving analog voice signals from a first side and modulating the analog voice signals by bluetooth technology;

converting the modulated analog voice signals to digital voice signals;

transmitting the digital voice signals to a second side through internet networks;

receiving digital voice signals and then converting the received digital voice signals to analog voice signals; and

broadcasting the received voice signals.

Furthermore, an apparatus to perform the foregoing steps is composed of:

a universal serial bus (USB) interface for connection to a computer;

a data distributing circuit connected to the USB interface, wherein the data distributing circuit receives data from or transmits data to the computer through the USB interface;

a bluetooth module connected to the data distributing data for wirelessly receiving and transmitting data;

a storage unit connected to the data distributing circuit for information storage; and

a power supply unit for providing an operating voltage;

wherein the data distributing circuit determines whether the received data should be transmitted to the bluetooth module or the data distributing circuit based on the type of the received data.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a telecommunication device in accordance with the present invention;

FIG. 2 is a circuit diagram of a data distributing unit in accordance with the present invention;

FIG. 3 is a circuit diagram of a bluetooth module in accordance with the present invention;

FIGS. 4A-4B are circuit diagrams of a device in accordance with the present invention;

FIG. 5 is a circuit diagram of a memory in the portable storage device in accordance with the present invention;

FIG. 6 is an operational view showing the telecommunication device of FIG. 1 is plugged to a computer; and

FIG. 7 is an operational view showing a user wearing a bluetooth ear set.

### DETAILED DESCRIPTION OF THE INVENTION

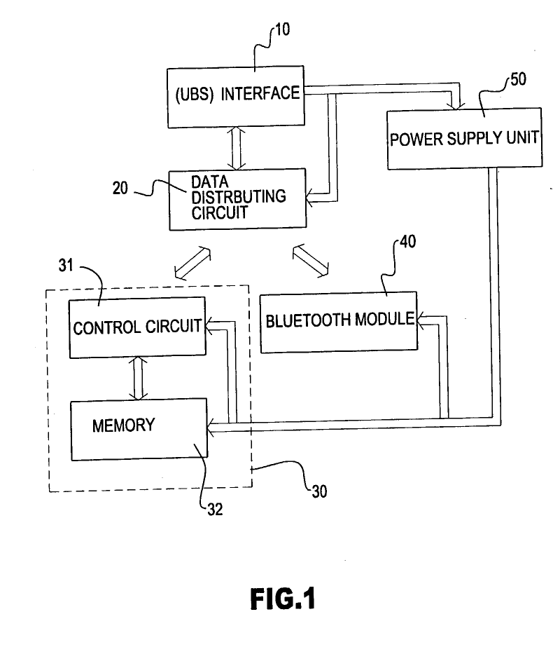

With reference to FIG. 1, a telecommunication apparatus (1) in accordance with the present invention includes a universal serial bus (USB) interface (10) for connection with a computer (not shown), a data distributing circuit (20), a storage unit (30), a bluetooth module (40) and a first power supply unit (50).

The data distributing circuit (20) connects to the USB interface (10) to receive data from the computer. Based on the type of the received data and verified identification (ID) information, the distributing circuit (20) transmits the received data to the storage unit (30) or the bluetooth module (40).

In the embodiment, the storage unit (30) is formed as a flash drive. The flash drive is a kind of a portable and plug-in flash memory device (hard disk) that allows the user to read/write information among different computers. The user can download desired information from a first computer, which can be further accessed by a second computer while the flash drive is plugged in to the second computer. The storage unit (30) is composed of a control unit (31) and a memory (32).

The bluetooth module (40) is able to wirelessly receive and transmit voice signals, wherein the operating voltage for the bluetooth module is obtained from the first power supply unit (50).

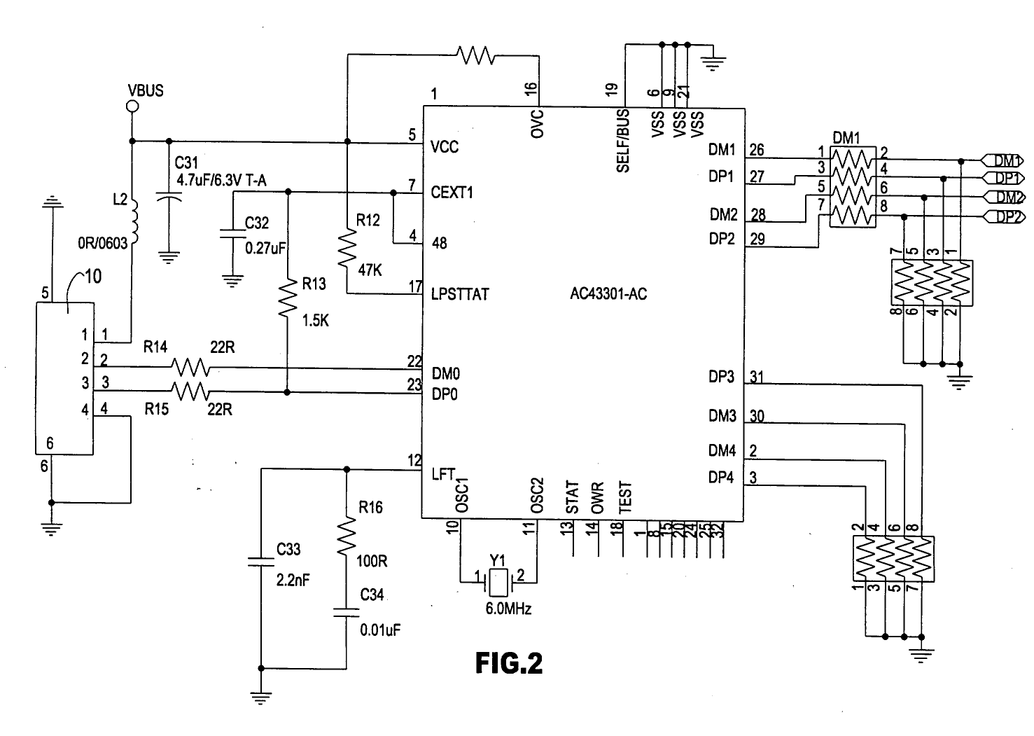

With reference to FIG. 2, the data distributing circuit (20) is an integrated circuit (IC) designated by AC43301-AC. Two input terminals (DM0, DP0) are connected to the USB interface (10). Two output terminals (DM1, DP1) are for connection to the storage unit (30), and another two output terminals (DM2, DP2) are for connection to the bluetooth module (40). The data distributing circuit (20) is deemed as a data relay device that temporarily stores data. After receiving the data from the computer, the data distributing circuit (20) determines that the received information should be outputted to the storage unit (30) or the bluetooth module (40).

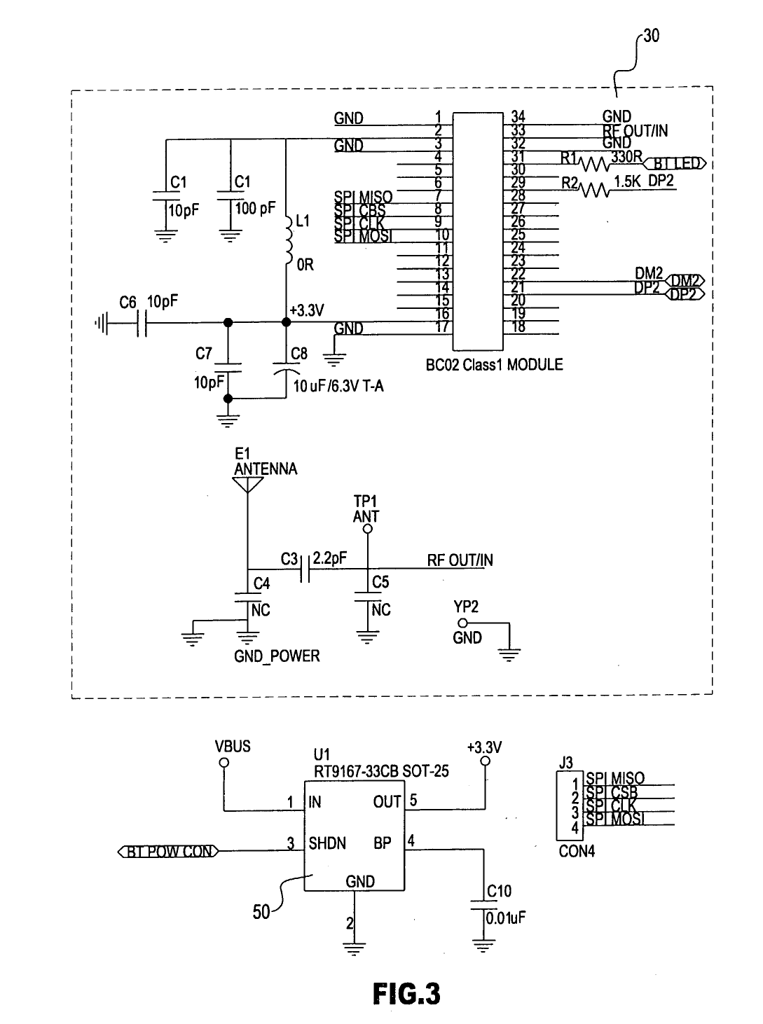

With reference to FIG. 3, the bluetooth module (40) is an IC designated by BC02, wherein one terminal (RF OUT/IN) is connected to an antenna so that the bluetooth module (40) is able to wirelessly transmit/receive data through the antenna.

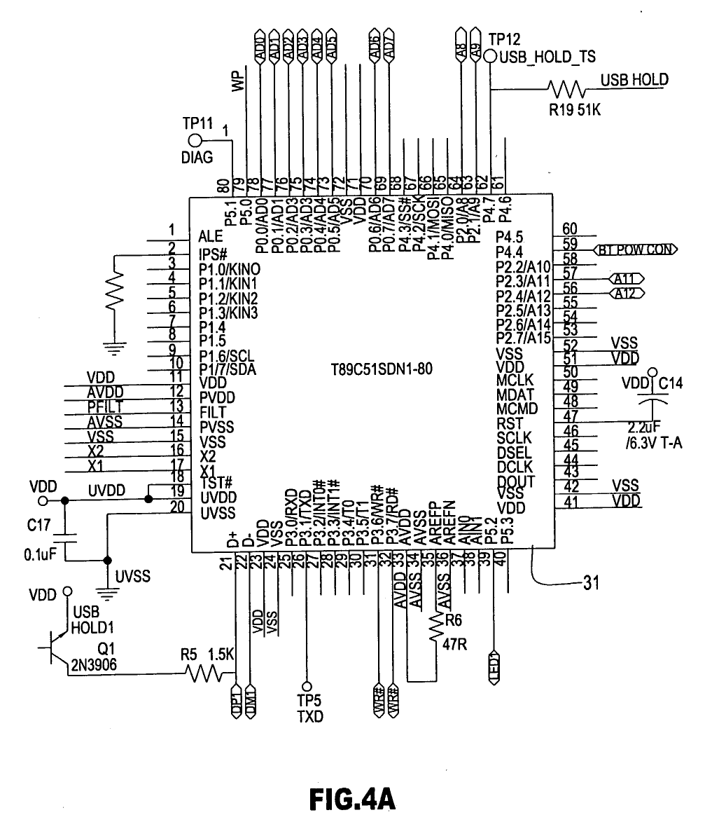

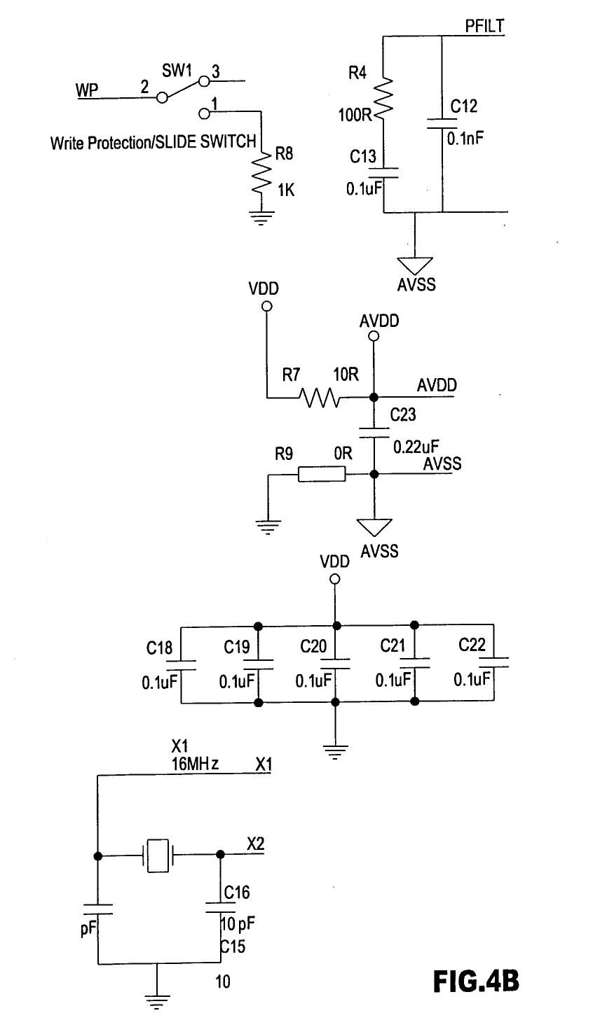

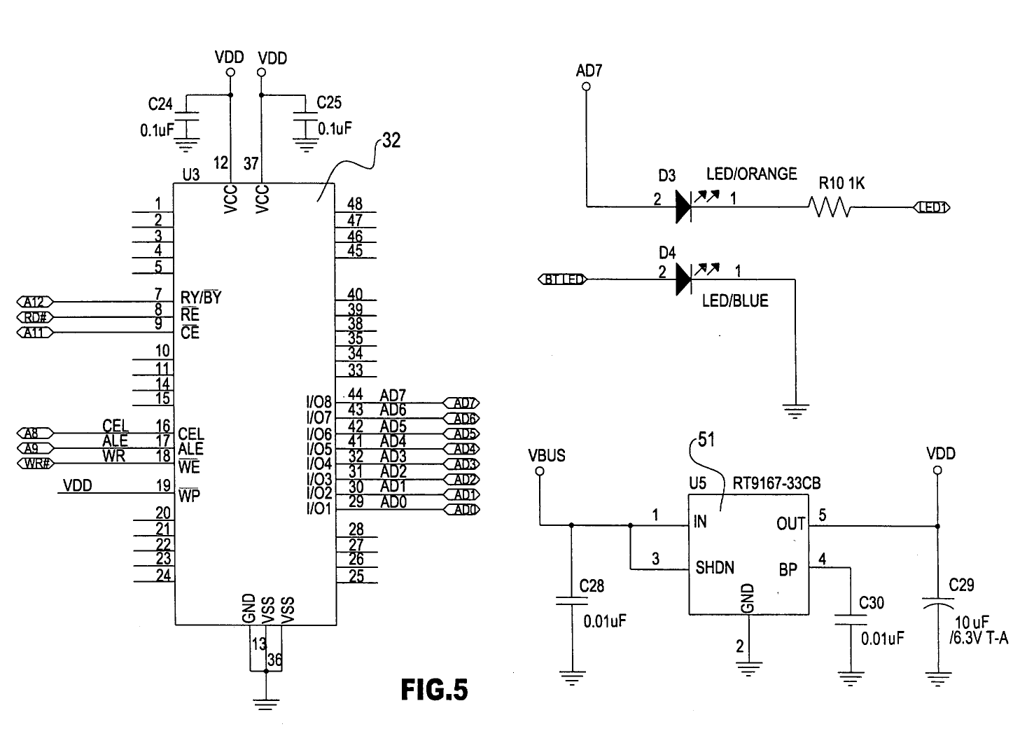

With reference to FIGS. 4A-4B and 5, the control unit (31) in the storage unit (30) is connected to the terminals (DM1, DP1) of the distributing circuit (20). Further, the address terminals (AD0-AD7) of the control unit (31) are connected to the memory (32), where the capacity of the memory (32) could be 16 MB, 32 MB, 64 MB or 128 MB etc. As shown in FIG. 5, a second power supply unit (51) provides the operating voltage to the storage unit (30).

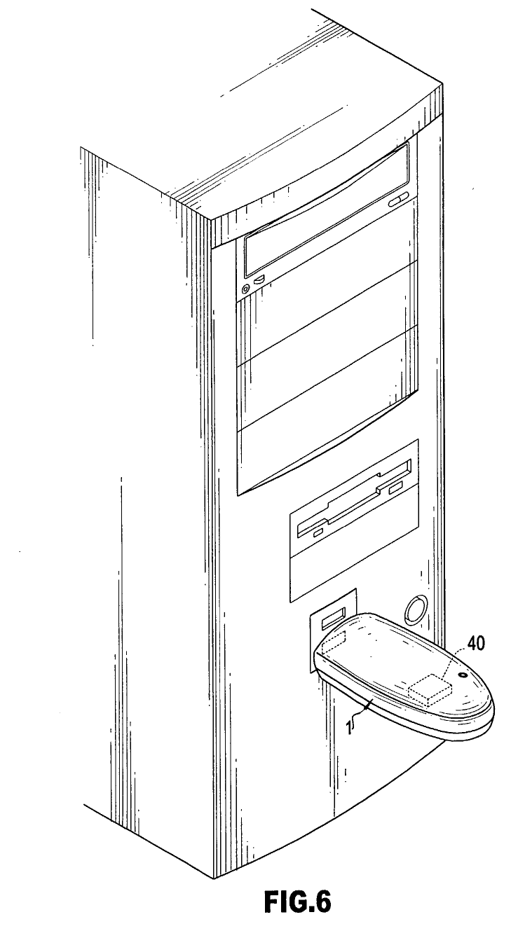

With reference to FIG. 6, the apparatus (1) of the present invention has the appearance substantially the same as a flash drive and is plugged to a USB port of the computer via the USB interface (10). When the apparatus (1) is detected by the computer, the computer treats the apparatus (1) as a flash drive and allows user to write data to or read data from the memory (32) inside the apparatus (1). Meanwhile the computer also executes a verifying process to identify the apparatus (1). Only when the verifying result of the apparatus (1) is valid can the identifying (ID) information be provided to the apparatus (1) and the bluetooth module (40) be activated. If the verifying result is invalid, the operating voltage will not be supplied to the bluetooth module (40).

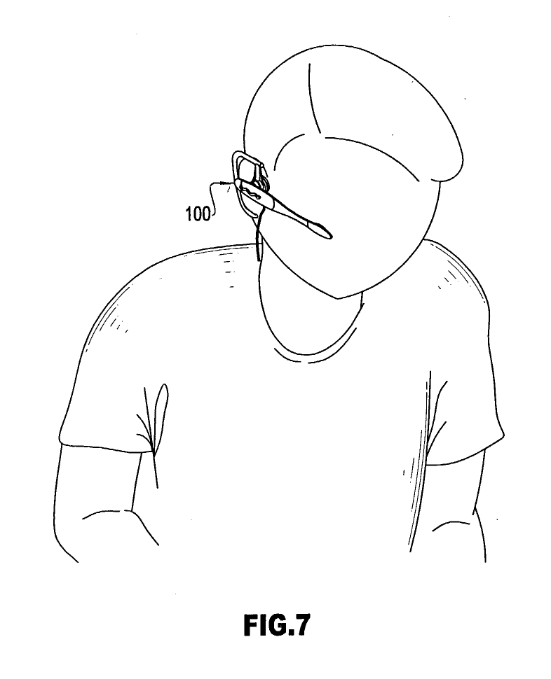

With reference to FIG. 7 if the user (the caller) intends to make a VoIP telecommunication with a remote person (the recipient), the caller just needs to wear a well known bluetooth ear set (100) that integrates the functions of an earphone and a microphone. The user further executes an application software program installed in the computer to control the apparatus (1). The software program can dial a user's designated phone number. After the computer successfully establishes the VoIP telecommunication between the user and the answer, the bluetooth ear set (100) will modulate the analog voice signal of the caller and then wirelessly transmit the modulated voice signals to the bluetooth module (40). The received modulated voice signals are further input to the computer through the data distributing circuit (20) and the USB interface (10). After which, the computer converts the modulated analog signals to digital signals, and transmits the digital voice signals through the internet network to the recipient, so the VoIP telecommunication is established.

Another situation is that the user acts as a recipient not a caller. If there are incoming voice signals input to the computer through the internet network, the application software controls the bluetooth module (40) to output a ring generating signal to the bluetooth ear set (100). Thereby the bluetooth ear set (100) will generate the ring sounds to notify the user that there is an incoming phone call. By pressing the control button on the bluetooth ear set (100), the ear set (100) receives the voice signals from the bluetooth module (40) so that the user is able to talk to the caller.

The foregoing VoIP telecommunication can be concluded as the following steps:

receiving analog voice signals from a first side and modulating the analog voice signals by bluetooth technology;

converting the modulated analog voice signals to digital voice signals;

transmitting the digital voice signals to a second side through internet networks;

receiving digital voice signals and then converting the received digital voice signals to analog voice signals; and

broadcasting the received voice signals.

Whether the user acts as a caller or a recipient, the advantage of the present invention is to provide a mobile VoIP telecommunication system. A user does not need to sit in front of the computer while making a VoIP telecommunication with a remote person because the voice signals are transmitted wirelessly between the computer and the user's ear set.

The invention may be varied in many ways by a skilled person in the art. Such variations are not to be regarded as a departure from the spirit and scope of the invention, and all such modifications are intended to be included within the scope of the following claims.

What is claimed is:

1. A method for establishing a voice-over IP (VoIP) telecommunication between a first side and a second side, the method comprising:
receiving analog voice signals from the first side and modulating the analog voice signals by a bluetooth module;
converting the modulated analog voice signals to digital voice signals;
transmitting the digital voice signals to the second side through internet networks;
converting the received digital voice signals from the first side to modulated analog voice signals by the second side;
demodulating the modulated analog voice signals; and
broadcasting the demodulated analog voice signals.

2. The method as claimed in claim 1, wherein the demodulating step is performed by a bluetooth ear set.

3. The method as claimed in claim 2, wherein the method further has a step to designate the second side as a party of the VoIP telecommunication before the step of digital voice signals transmission.

4. An apparatus for establishing a voice-over IP (VoIP) telecommunication, the apparatus comprising:
a universal serial bus (USB) interface for connection to a computer;
a data distributing circuit connected to the USB interface, wherein the data distributing circuit receives data from or transmits data to the computer through the USB interface;
a storage unit connected to the data distributing circuit for storage data transmitted from the computer;
a bluetooth module connected to the data distributing data for wirelessly receiving and transmitting voice data; and
wherein the voice data received by the bluetooth module is transmitted over internet networks to establish the VoIP telecommunication.

5. The apparatus as claimed in claim 4, wherein the storage unit is a flash drive.

6. The apparatus as claimed in claim 4, wherein when the apparatus is plugged to the computer via the USB interface, a verifying process executed by the computer is performed on the apparatus, and the bluetooth module is activated if the verifying result is valid.

7. The apparatus as claimed in claim 5, wherein the flash drive comprises a control circuit connected to the data distributing circuit and a memory connected to the control circuit.
